(19) United States
(12) Patent Application Publication
(10) Pub. No.: US 2009/0022083 A1
(43) Pub. Date: Jan. 22, 2009

(54) METHOD OF SYNCHRONIZING FRAME IN MMR NETWORK

(75) Inventors: Dong Hyun AHN, Daejeon-city (KR); Junhong HUI, Daejeon-city (KR); Choongil YEH, Daejeon-city (KR); Young il KIM, Daejeon-city (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/174,103

(22) Filed: Jul. 16, 2008

(30) Foreign Application Priority Data
Jul. 16, 2007 (KR) 10-2007-0071268
Jul. 15, 2008 (KR) 10-2008-0068497

(51) Int. Cl. H04J 3/06

(52) U.S. Cl. 370/315

(57) ABSTRACT

Provided is a method of synchronizing a frame using a cycle prefix (CP) in a mobile multi-hop relay (MMR) network. The frame is synchronized using the CP of the frame after obtaining a frame synchronization using a preamble of the frame, which does not need an additional preamble, so that a preamble necessary for the frame synchronization is transmitted to a subordinate station during a preamble receiving section.

### CROSS-REFERENCE TO RELATED PATENT APPLICATION

This application claims the benefit of Korean Patent Application Nos. 10-2007-0071268, filed on Jul. 16, 2007, 10-2008-0068497, filed on Jul. 15, 2008, in the Korean Intellectual Property Office, the disclosure of which is incorporated herein in its entirety by reference.

### BACKGROUND OF THE INVENTION

1. Field of the Invention

The present invention relates to a method of synchronizing a mobile multi-hop relay (MMR) network, and more particularly, to a method of synchronizing a frame using a cycle prefix (CP) in OFDM symbol.

The present invention is derived from a research project partly supported by the Information Technology (IT) Research & Development (R&D) program of the Ministry of Information and Communication (MIC) and the Institute for Information Technology Advancement (IITA) [2006-S-011-01, Development of Relay Mesh Communication System for Multi-hop WiBro].

2. Description of the Related Art

In a mobile multi-hop relay (MMR) network, a relay station (RS) necessarily receives a frame from its parent station (a RS or a base station (BS)) and transfers information regarding the frame to the subordinate stations (RSs or mobile stations (MSs)).

The subordinate stations (RSs or MSs) must adjust the frame synchronization by using a preamble so as to receive correct information regarding the frame. However, it is very difficult to transfer the preamble to the subordinate stations (RSs or MSs) while receiving the preamble from the parent station (RS or BS). Accordingly, it is difficult to synchronize a frame in the subordinate stations.

### SUMMARY OF THE INVENTION

The present invention provides a method of synchronizing a frame by transferring a preamble to a subordinate station while receiving the frame from a parent station.

According to an aspect of the present invention, there is provided a method of synchronizing a frame of a relay station in a mobile communication network, the method comprising: transmitting a preamble to a subordinate station; and correcting a frame synchronization using cycle prefix (CP) in OFDM symbol of a frame received from a parent station.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a frame used for a wireless communication between a parent station and a subordinate station according to an embodiment of the present invention;

FIG. 2 is a flowchart illustrating a method of synchronizing a frame according to an embodiment of the present invention; and

FIG. 3 illustrates the synchronization of a cycle prefix (CP) in the IEEE 802.16e specification according to an embodiment of the present invention.

### DETAILED DESCRIPTION OF THE INVENTION

Hereinafter, the present invention will be described in detail by explaining exemplary embodiments of the invention with reference to the attached drawings.

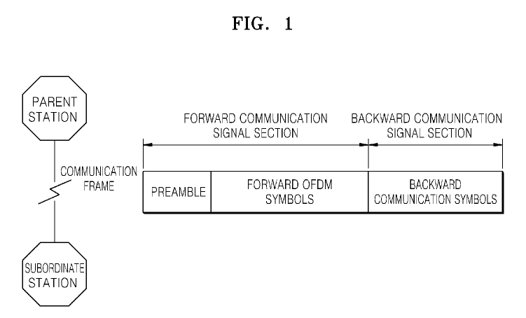

FIG. 1 illustrates a structure of a frame used for a wireless communication between a parent station and a subordinate station according to an embodiment of the present invention. Referring to FIG. 1, a frame comprises a preamble, forward orthogonal frequency division multiplexing (OFDM) symbols and backward communication symbols. The preamble and forward OFDM symbols are used during a forward communication signal section. The backward communication symbols are used during a backward communication signal section.

Meanwhile, all data busts comprise a plurality of OFDM symbols each comprising a cycle prefix (CP) and an OFDM data symbol.

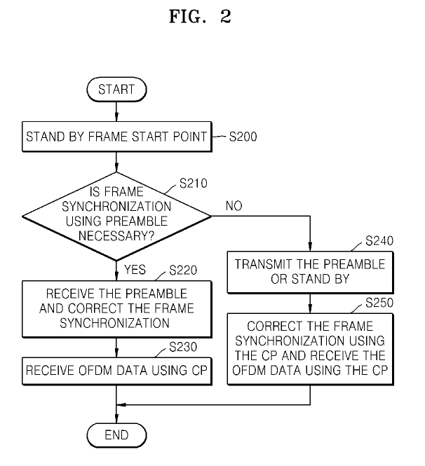

FIG. 2 is a flowchart illustrating a method of synchronizing a frame according to an embodiment of the present invention. Referring to FIG. 2, in operation 200, a relay station (RS) stands by a frame start point in a mobile multi-hop relay (MMR) system that uses an OFDM modulation, and, in operation 210, determines if a synchronization using a preamble is necessary. If it is determined that the synchronization using the preamble is necessary, in operation 220, the RS receives the preamble and corrects the synchronization of the frame, and, in operation 230, receives OFDM symbols using a CP.

For example, when the RS enters into a new network, since the RS has no subordinate station (RS or mobile station (MS)), the RS receives a frame, like a general terminal, obtains the frame synchronization using a preamble of the frame. Also, when it is no longer possible to receive OFDM data symbols by losing the frame synchronization maintained by the RS, the RS receives a preamble of another frame, and reconstructs the frame synchronization.

If it is determined that the synchronization using the preamble is not necessary, in operation 240, the RS transfers the preamble to a lower wireless station or stands by the frame from the parent station. And, in operation 250, The RS corrects the frame synchronization using the CP of the frame and receives the OFDM symbols using the CP.

For example, when the RS enters into a new network, the RS performs synchronization using a preamble. However when the RS starts the original function of the RS, i.e., a relay function by communicating with its parent station (RS or BS), the RS synchronizes the frame using CPs included in OFDM symbols. Therefore, when the RS synchronizes the frame using the CP, since it is possible to maintain the frame synchronization and it is unnecessary to receive a preamble, the RS can transfer the preamble to its subordinate station during a preamble receiving section.

If the frame synchronization using the CP is impossible, the RS receives a preamble from the parent station again, adjusts the frame synchronization, and returns to a frame synchronization mode that uses the CP.

In summary, in order to maintain the frame synchronization with respect to a parent station and transfer a preamble used for the frame synchronization to a subordinate stations in the MMR system that uses the OFDM modulation, the RS initially receives a perfect frame including the preamble from a parent station and maintains the frame synchronization with respect to the parent station. And then, the RS transfers a preamble designed for the maintained synchronization of the frame to the subordinate stations. The RS receives CPs of OFDM symbols that are received with the maintained synchronization of the frame and corrects the synchronization of the frame using the CPs. If it is impossible to receive OFDM data symbols by losing the maintained synchronization of the frame, the RS receives a preamble of a next frame and reconstructs the frame synchronization.

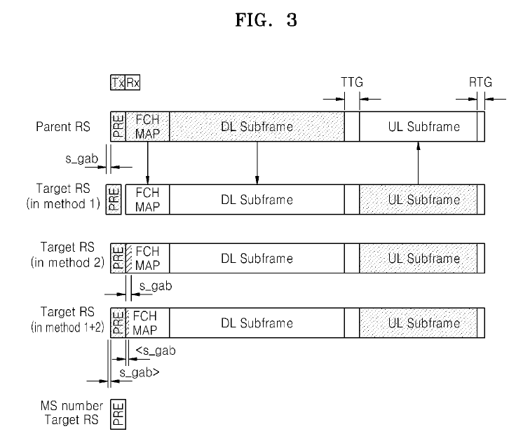

FIG. 3 illustrates the synchronization of a CP in the IEEE 802.16e specification according to an embodiment of the present invention. Referring to FIG. 3, s-gap is a time section necessary for switching a transmission mode to a receiving mode in the wireless stations (BS, RS, MS, etc.) According to a first method, a target RS transmits a preamble to a subordinate station before a frame starts, switches to the receiving mode, and receives OFDM symbols in accordance with the frame synchronization. According to a second method, the RS transmits the preamble to the subordinate station in accordance with the frame synchronization, switches to the receiving mode, and receives the OFDM symbols. In this regard, the RS cannot receive a part of a CP of a first OFDM symbol. However, since the whole length of the CP is quite greater than the time section, s-gap, and although the part of the CP is damaged, the time section is short, it is not difficult to synchronize the CP. A third method is a combination of the first and second methods.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

According to the present invention, a CP of a frame is used to maintain a frame sync, which does not need to receive a separate preamble, thereby transferring the preamble to a subordinate station during a preamble receiving section.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of synchronizing a frame of a relay station in a mobile communication network, the method comprising:
transmitting a preamble to a subordinate station; and
correcting a frame synchronization using cycle prefixes (CPs) in OFDM symbols of a frame received from a parent station.

2. The method of claim 1, further comprising: when the frame synchronization is lost, obtaining the frame synchronization using a preamble of the frame received from the parent station.

3. The method of claim 1, wherein transmitting of the preamble to the subordinate station comprises: switching to a receiving mode after transmitting the preamble to the subordinate station before receiving the frame from the parent station.

4. The method of claim 3, wherein transmitting of the preamble to the subordinate station comprises: transmitting the preamble to the subordinate station before the time gap for switching from a transmission mode to the receiving mode before receiving the frame from the parent station.

5. The method of claim 1, wherein transmitting of the preamble to the subordinate station comprises: switching to the receiving mode after transmitting the preamble to the subordinate station in accordance with the current frame synchronization.
